(19) United States
(12) Patent Application Publication
(10) Pub. No.: US 2022/0277246 A1
(43) Pub. Date: Sep. 1, 2022

(54) Method for Coordinating an Autonomous Vehicle Fleet, and Vehicle Fleet Coordination System

(71) Applicant: Daimler AG, Stuttgart (DE)

(72) Inventor: Bernd WOLTERMANN, Fellbach (DE)

(21) Appl. No.: 17/625,538

(22) PCT Filed: Jul. 1, 2020
(86) PCT No.: PCT/EP2020/068517

§ 371 Date: Jan. 7, 2022

(30) Foreign Application Priority Data
Jul. 8, 2019 (DE) 10 2019 004 753.2

(51) Int. Cl. G06Q 10/06; G08G 1/00; G05D 1/02; G01C 21/34; G06N 3/02

(52) U.S. Cl. CPC G06Q 10/06315; G08G 1/202; G05D 1/0291; G01C 21/3438; G01C 21/3469; G01C 21/3484; G01C 21/3492; G06N 3/02; G05D 2201/0213

(57) ABSTRACT

A method for coordinating an autonomous vehicle fleet that includes a plurality of autonomous motor vehicles in a predetermined first region by a vehicle fleet coordination system. The method includes coordinating the autonomous vehicle fleet depending on a first regional environment profile of the predetermined first region, where a position in the predetermined first region dependent on the first regional environment profile is autonomously approached by a first autonomous motor vehicle of the plurality of autonomous motor vehicles. The method further includes generating the first regional environment profile on a basis of a second regional environment profile which is stored in an electronic computing device of the vehicle fleet coordination system and which is generated for a second region independent of the predetermined first region.

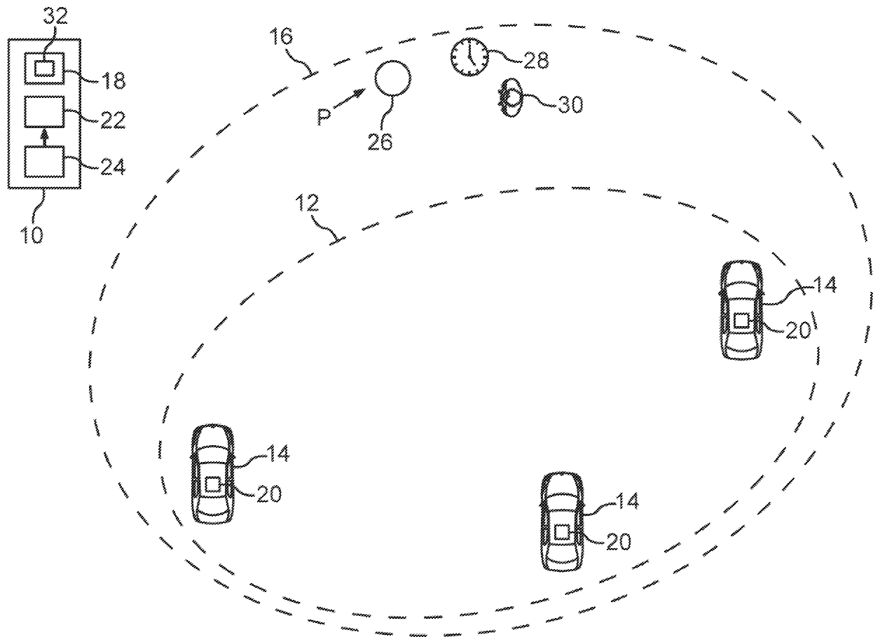

### BACKGROUND AND SUMMARY OF THE INVENTION

The invention relates to a method for coordinating an autonomous vehicle fleet comprising a plurality of autonomous motor vehicles in a predetermined first region by means of a vehicle fleet coordination system. The invention also relates to a vehicle fleet coordination system.

It is known that autonomous motor vehicles, especially so-called “autonomous shuttles” for ride-sharing or ride-hailing, are only available in small numbers at the beginning of an installation of these vehicles in certain cities. This is due, among other things, to the complexity of the motor vehicles, but also to the high costs of the various sensor systems and other technology. This means, in particular, that these motor vehicles should only have few idle times and should be on the road with several passengers at all times to the greatest possible extent. However, the planning for the charging strategy of the vehicles and also the routes travelled must be adapted accordingly.

In this regard, it is known from the prior art that the daily use of the multitude of passengers can be used to predict at what time and at what place there will be a particularly high demand. For example, it can be determined that at certain times, especially in the afternoon, for example at a large factory or a large company, a large number of possible people can be found who want to use the autonomous shuttle. Outside of these regular times, however, prediction is complicated.

US 2018/0096606 A1 discloses a method for providing dispatch services for on-demand transportation. The method includes determining that a predictive assignment message is to be transmitted to a motor vehicle, generating the predictive assignment message in response to determining that a predictive assignment is to be transmitted to a motor vehicle, and transmitting the predictive assignment message to the vehicle. Generating the predictive assignment message uses one or more predictive models calculated from historical and real-time on-demand transportation service data.

It is the object of the present invention to create a method and a vehicle fleet coordination system by means of which the autonomous motor vehicles can be coordinated in an improved manner.

This object is achieved by a method and by a vehicle fleet coordination system according to the independent claims. Advantageous embodiments are indicated in the dependent claims.

One aspect of the invention relates to a method for coordinating an autonomous vehicle fleet comprising a plurality of autonomous motor vehicles in a predetermined first region by means of a vehicle fleet coordination system, in which the vehicle fleet is coordinated depending on a first regional environment profile of the first region for the vehicle fleet coordination system, wherein, for coordination, a particular position in the first region dependent on the regional environment profile is autonomously approached by means of a particular motor vehicle from the plurality of motor vehicles.

It is provided that the first regional environment profile is generated on the basis of a second regional environment profile, which is stored in an electronic computing device of the vehicle fleet coordination system and is generated for a second region independent of the first region.

This makes it possible to implement improved coordination of the autonomous motor vehicles in the autonomous vehicle fleet.

The reason for this is in particular that, for example, similar events take place in the second region as in the first region. A particular city can be regarded as a particular region. For example, the city of Berlin can be considered as the second region and the city of Stuttgart as the first region. Thus, it is provided that on the basis of the generated environment profile for Berlin, the environment profile for the city of Stuttgart is now generated. In particular, if the autonomous vehicle fleet is to be rolled out in Stuttgart, for example, corresponding attributes are then specified on the basis of the already generated environment profile for Berlin and can be used as a starting point for the regional environment profile. In particular, the environment profile is characterized by corresponding events within the regions. In particular, the events have a position that is then approached by a particular autonomous vehicle.

In particular, it is thus solved in accordance with the invention that in the first region there are, for example, a large number of events at different locations, in other words positions, on a daily basis, but only some of these events will lead to a large number of driving jobs for the autonomous vehicle fleet. This issuing of driving jobs depends mainly on the location of the event, the time, but also mainly on the people involved. For example, after a pop concert, the probability that the autonomous vehicle fleet will be used is higher than after a classical concert due to the age mix.

According to an advantageous embodiment, the first regional environment profile is generated on the basis of a plurality of stored further regional environment profiles, which are generated for a plurality of further regions independent of the first region. In other words, the regional environment profile is generated depending on a plurality of further regional environment profiles that have already been generated. This makes it possible to fall back on a plurality of already generated environment profiles, whereby an already very detailed regional environment profile can be generated. This means that reliable coordination of the autonomous motor vehicles can be realised already when a service only starts to be provided by the autonomous vehicle fleet.

In a further advantageous embodiment, the first regional environment profile is adapted depending on regional gatherings in the first region. In other words, it is provided that the first regional environment profile is generated based on the at least second regional environment profile. Over time, the first regional environment profile is then adapted accordingly depending on the regional gatherings in the first region. In particular, it can be provided that information for these gatherings can be drawn, for example, from the Internet. In particular, the regional gatherings can be events which are typically collected and which are available, for example, on the Internet, for example in a calendar of events, and which can then be searched via the electronic computing device. When the autonomous vehicle fleet is then rolled out in the first region, the data of the second regional environment profile can first be used or, alternatively, manually assigned attributes can be specified, with which the events, in other words the regional gatherings, are marked, and the autonomous motor vehicles can then be guided on the basis of these attributes to the vicinity of the event locations, in other words to the position, in a pre-planned manner. Using the actual incoming driving jobs and the matching positions, the actual imprint regarding events can then be learned for this first region and thus the typical users of shuttles can be assigned to the events that are typical for them. In this way, the first environment profile can be generated precisely, which leads to improved coordination of the autonomous vehicle fleet.

Furthermore, it has proven to be advantageous if the first regional environment profile is adjusted in time and/or location depending on the regional gatherings. In other words, in particular a spatiotemporal adaptation of the regional environment profile takes place. In particular, an imprint with regard to the events can thereby be provided for the first region. The first regional environment profile is thus adapted in respect of time and/or location to the gatherings taking place in the first region, which then allows the first regional environment profile to be adapted. In particular, this enables the coordination of the autonomous vehicle fleet to be adapted to the first region.

In a further advantageous embodiment, the first regional environment profile is adapted depending on the duration of the regional gatherings. In other words, it can be provided that typical event lengths of the gatherings are “learned” by means of the electronic computing device. For example, an event regularly lasts two hours. Thus, the user of the autonomous motor vehicle issues their driving request two hours after the start of the event and wants to be picked up as soon as possible. By using the time duration accordingly, the first regional environment profile can thus be generated precisely. This leads to improved coordination of the autonomous vehicle fleet in the first region.

In a further advantageous embodiment, person profiles are generated for the various regional gatherings by means of the electronic computing device, and the first environment profile is adapted depending on the generated person profiles. In particular, the person profile can, for example, take into account an average age of a gathering. Furthermore, it can be provided, for example, that the gathering, for example a football match, is evaluated with the person profile to the effect that, after the football match, people regularly want to travel to the main station of the particular first region. This can then be taken into account in order to realise the coordination of the autonomous vehicle fleet.

Furthermore, it has proven to be advantageous if a route planning of the various motor vehicles and/or a battery charge planning of the various motor vehicles and/or an idle time planning of the various motor vehicles is carried out as coordination by means of the electronic computing device. In particular, it is necessary for improved coordination of the autonomous vehicle fleet that a corresponding route planning and/or battery charge planning and/or idle time planning is carried out. Thus, for example, idle times of the autonomous motor vehicles can be reduced. By taking into account or planning accordingly, improved coordination of the autonomous vehicle fleet can then be realised.

According to a further advantageous embodiment, journeys requested by people are rejected depending on the generated first environment profile. In particular, it can be provided for this purpose that journeys can also be rejected during the planning of the corresponding journeys, for example if they would result in the necessary fleet size not being reached at the event location at a certain time. Alternatively or additionally, in the case of ride sharing, larger areas could be created from which customers are picked up and dropped off in order to have to use fewer motor vehicles. In this way, an improved coordination of the autonomous vehicle fleet can be realised.

It is also advantageous if the first environment profile is adapted to the electronic computing device by means of machine learning, in particular by means of a neural network. In other words, it is provided that the electronic computing device is taught and the first environment profile is actively adapted in real time by the teaching process. This makes it possible to adapt the first regional environment profile to the current gatherings within the first region, thereby enabling improved coordination of the vehicle fleet.

Another aspect of the invention relates to a vehicle fleet coordination system for coordinating an autonomous vehicle fleet comprising a plurality of autonomous motor vehicles in a predetermined first region, comprising at least one electronic computing device, wherein the vehicle fleet coordination system is designed to perform a method according to the preceding aspect. In particular, the method is performed by means of the vehicle fleet coordination system.

Advantageous embodiments of the method are to be regarded as advantageous embodiments of the vehicle fleet coordination system. For this purpose, the vehicle fleet coordination system has objective features which enable the method or an advantageous embodiment thereof to be carried out.

Further advantages, features and details of the invention will become apparent from the following description of a preferred exemplary embodiment and from the drawing. The features and combinations of features mentioned above in the description as well as the features and combinations of features mentioned below in the FIGURE description and/or shown alone in the single FIGURE can be used not only in the combination indicated in each case, but also in other combinations or on their own, without departing from the scope of the invention.

### BRIEF DESCRIPTION OF THE DRAWING

The single FIGURE shows a schematic side view of an embodiment of a vehicle fleet coordination system.

### DETAILED DESCRIPTION OF THE DRAWING

In the FIGURE, like or functionally like elements are provided with like reference signs.

The FIGURE shows a schematic side view of an embodiment of a vehicle fleet coordination system 10. The vehicle fleet coordination system 10 is designed to coordinate an autonomous vehicle fleet 12 comprising a plurality of autonomous motor vehicles 14 in a predetermined first region 16. The vehicle fleet coordination system 10 comprises at least one electronic computing device 18. It may further be provided, for example, that a particular autonomous motor vehicle 14 comprises a corresponding electrical energy storage device 20, which can also be referred to as a battery. In other words, it can be provided that the autonomous motor vehicle 14 is an at least partially electrically operated motor vehicle 14, in particular a fully electrically operated autonomous motor vehicle 14.

In the method for coordinating the autonomous vehicle fleet 12 with the plurality of autonomous motor vehicles 14, which in the present case has in particular three autonomous motor vehicles 14, the autonomous vehicle fleet 12 is coordinated in the predetermined first region 16 by means of the vehicle fleet coordination system 10 depending on a first regional environment profile 22 of the first region 16 for the vehicle fleet coordination system 10, wherein, for coordination, a particular position P in the first region 16 dependent on the regional environment profile 22 is autonomously approached by means of a particular autonomous motor vehicle 14 from the plurality of autonomous motor vehicles 14.

It is provided that the first regional environment profile 22 is generated on the basis of a second regional environment profile 24, which is stored in the electronic computing device 18 of the vehicle fleet coordination system 10 and is generated for a second region independent of the first region 16.

The first region is in particular a first city, and the second region is in particular a second city independent of the first city. It is further understood that more than three autonomous motor vehicles 14 can also be coordinated.

In particular, it can be provided that the first regional environment profile 22 is generated on the basis of a plurality of stored further regional environment profiles, which are generated for a plurality of further regions independent of the first region 16.

Furthermore, it can be provided in particular that the first regional environment profile 22 is adapted depending on regional gatherings 26 in the first region 16. The regional gatherings 26 are in particular events within the first region 16. These regional gatherings 26 can be determined, for example, by evaluating a calendar of events for the first region 16.

Furthermore, it can be provided that the first regional environment profile 22 is adapted in respect of time and/or location depending on the regional gatherings 26. In particular, a spatiotemporal adaptation of the first regional environment profile 22 can thus be carried out.

Furthermore, it can be provided that the first regional environment profile 22 is adapted depending on a particular time duration 28 of the regional gatherings 26.

It can further be provided that individual person profiles 30 are generated by the electronic computing device 18 for the various regional gatherings 26, and the first regional environment profile 22 is adapted depending on the generated person profiles 30.

In particular, it can be provided for this purpose that a route planning of the various autonomous motor vehicles 14 and/or a battery charge planning of the various autonomous motor vehicles 14, in particular a battery charge voltage of the corresponding electrical energy storage devices 20, and/or an idle time planning of the various autonomous motor vehicles 14 are carried out as coordination by means of the electronic computing device 18.

Furthermore, it can be provided in particular that requested journeys of persons are rejected depending on the generated first regional environment profile 22.

Furthermore, it can be provided that the first regional environment profile 22 is adapted by means of machine learning, in particular by means of a neural network 32, of the electronic computing device 18.

In particular, the invention takes advantage of the fact that in a city, which in this case corresponds to the first region 16, there are multiple gatherings 26, which can also be called events, taking place every day at different locations, in particular at different positions P, but only some of these gatherings 26 will result in a large number of driving jobs for the autonomous vehicle fleet 12. These depend on the location of the gathering 26, on the time, but mainly also on the people. For example, after a pop concert there is very likely to be a higher number of driving jobs for the autonomous vehicle fleet 12 than after a classical concert due to the age mix.

These gatherings can typically be collected and are available on the Internet and can be searched via the electronic computing device 18, for example. When the autonomous vehicle fleet 12 is to be rolled out in a new city, in this case the first region 16, data based on other cities, i.e., the second region, and the associated second regional environment profile 24 are used. Alternatively, data can also be entered manually. The corresponding gatherings 26 are then marked, and the autonomous motor vehicles 14 can then be guided to the vicinity of the event locations in a pre-planned manner on the basis of these attributes. Using the actual incoming bookings and the corresponding pick-up locations, the actual imprint regarding the events can then be learned for this city and thus the typical users can be assigned by the autonomous vehicle fleet 12 to the events that are typical for them. Additionally, typical event lengths can also be learned. For example, a certain play has a duration 28 of two hours, so that the electronic computing device 18 knows that, two hours after the start of the event, corresponding driving jobs are received, which should be processed as quickly as possible. In addition, the destination can also be used to learn where the typical customer of such an event would like to be driven to. For example, it can be provided that after a football match the person in question often wants to be driven to the main station of the first region 16. This knowledge can again be used for further scheduling of the autonomous vehicle fleet 12.

Via these personal preferences of the typical autonomous motor vehicle user, the autonomous vehicle fleet 12 can then be positioned in such a way that the journeys are planned in advance, but also the planning with regard to the battery charging of the motor vehicles 14 and thus necessary idle times are improved.

When planning the journeys, journeys can also be rejected if they would mean that the necessary fleet size is not reached at the event location, i.e., at the gathering 26, at a certain time of day. Alternatively or additionally, in the case of “ride sharing”, larger areas could be created from which the customers are picked up and dropped off in order to have to use fewer autonomous motor vehicles 14.

Overall, the invention shows automatic positioning of autonomous motor vehicles 14.

1.-10. (canceled)

11. A method for coordinating an autonomous vehicle fleet that includes a plurality of autonomous motor vehicles in a predetermined first region by a vehicle fleet coordination system, comprising the steps of:
coordinating the autonomous vehicle fleet depending on a first regional environment profile of the predetermined first region, wherein a position in the predetermined first region dependent on the first regional environment profile is autonomously approached by a first autonomous motor vehicle of the plurality of autonomous motor vehicles; and
generating the first regional environment profile on a basis of a second regional environment profile which is stored in an electronic computing device of the vehicle fleet coordination system and which is generated for a second region independent of the predetermined first region.

12. The method according to claim 11, wherein the first regional environment profile is generated on a basis of a plurality of stored further regional environment profiles generated for a plurality of further regions independent of the predetermined first region.

13. The method according to claim 11, wherein the first regional environment profile is adapted depending on regional gatherings in the predetermined first region.

14. The method according to claim 13, wherein the first regional environment profile is adapted in respect of time and/or location depending on the regional gatherings.

15. The method according to claim 13, wherein the first regional environment profile is adapted depending on a time duration of the regional gatherings.

16. The method according to claim 13, wherein individual person profiles are generated for the regional gatherings by the electronic computing device and wherein the first regional environment profile is adapted depending on the generated individual person profiles.

17. The method according to claim 11, wherein a route planning of the plurality of autonomous motor vehicles and/or a battery charge planning of the plurality of autonomous motor vehicles and/or an idle time planning of the plurality of autonomous motor vehicles are carried out as coordination by the electronic computing device.

18. The method according to claim 11, wherein, depending on the generated first regional environment profile, requested journeys of people are rejected.

19. The method according to claim 11, wherein the first regional environment profile is adapted by a neural network of the electronic computing device.

20. A vehicle fleet coordination system for coordinating an autonomous vehicle fleet that includes a plurality of autonomous motor vehicles in a predetermined first region, comprising:
an electronic computing device, wherein the vehicle fleet coordination system is configured to perform the method according to claim 11.
